(19) United States
(12) Patent Application Publication
(10) Pub. No.: US 2025/0333054 A1
(43) Pub. Date: Oct. 30, 2025

(54) STEERING CONTROL DEVICE

(71) Applicant: TOYOTA JIDOSHA KABUSHIKI KAISHA, Toyota-shi Aichi-ken (JP)

(72) Inventor: Wataru KAWASHIMA, Nisshin-shi Aichi (JP)

(73) Assignee: TOYOTA JIDOSHA KABUSHIKI KAISHA, Toyota-shi Aichi-ken (JP)

(21) Appl. No.: 19/184,571

(22) Filed: Apr. 21, 2025

(30) Foreign Application Priority Data
Apr. 30, 2024 (JP) 2024-073851

(51) Int. Cl. B60W 30/12

(52) U.S. Cl. CPC B60W 30/12; B60W 2420/403; B60W 2552/53; B60W 2710/20

(57) ABSTRACT

A steering control device includes: a path generation unit configured to generate a target path including a target lateral position in a traveling lane of a vehicle based on a captured image in front of the vehicle; a learning value calculation unit configured to, when a driver of the vehicle is performing a manual steering operation during a steering control, calculate a learning value for correcting the target lateral position based on a deviation amount of a manual path of the vehicle that follows the manual steering operation from the target lateral position in the target path; and a steering control unit configured to execute the steering control based on the target path and the learning value. The learning value calculation unit calculates a first learning value when the vehicle is traveling on a straight road, and a second learning value when the vehicle is traveling on a curved road.

### CROSS-REFERENCE TO RELATED APPLICATION

This application is based upon and claims the benefit of priority from Japanese Patent Application No. 2024-073851, filed on Apr. 30, 2024, the entire contents of which are incorporated herein by reference.

### TECHNICAL FIELD

The present disclosure relates to a steering control device.

### BACKGROUND

For example, in the self-position estimation device described in JP2017-013586, when it is determined that there is a steering override, lateral position control is interrupted after being determined as such, and when it is determined that the steering override has ended, lateral position control is resumed. A difference between the vehicle position based on GPS information and the vehicle position based on map information is regarded as an inherent position error of the GPS information, and this inherent position error is reflected in the vehicle position at the end of the steering override.

### SUMMARY

In the past, for example, if there is an assembly error at the shipping stage or if the user inadvertently touches the camera used for steering control, the mounted orientation of the camera may deviate from an ideal state. The influence of such orientation deviation on the lateral position error of the vehicle may vary between a straight section and a curved section. Therefore, there is room for improvement in correcting the error.

An example of the present disclosure is a steering control device configured to execute steering control including steering assistance or automatic steering of a vehicle. The steering control device includes: a path generation unit configured to generate a target path including a target lateral position in a traveling lane of the vehicle based on a captured image in front of the vehicle; a learning value calculation unit configured to, when a driver of the vehicle is performing a manual steering operation while the steering control is being executed, calculate a learning value for correcting the target lateral position based on an amount of deviation of a manual path of the vehicle that follows the manual steering operation from the target lateral position in the target path,; and a steering control unit configured to execute the steering control based on the target path and the learning value. The learning value calculation unit calculates a first learning value that is the learning value when the vehicle is traveling on a straight road, and a second learning value that is the learning value when the vehicle is traveling on a curved road.

In the steering control device according to an example of the present disclosure, the first learning value for a straight road and the second learning value for a curved road are calculated as learning values for correcting the target lateral position. Here, the lateral position error of the vehicle on the traveled road can arise from a deviation in the mounted orientation of the camera that obtains the captured image. The lateral position error caused by the orientation deviation is not uniform between a straight road and a curved road. For example, the lateral position error caused by the orientation deviation may be greater on a curved road than on a straight road. According to the configuration, the first learning value for a straight road and the second learning value for a curved road can be calculated as mutually different values. Hence, it is possible to calculate a learning value that corrects the target lateral position according to the magnitude of the influence of the orientation deviation on the lateral position error.

In one example, the learning value calculation unit may calculate a right learning value that is the second learning value when the vehicle is traveling on a right curved road, and a left learning value that is the second learning value when the vehicle is traveling on a left curved road.

In one example, the learning value calculation unit may calculate the learning value so that the learning speed of the second learning value is faster than the learning speed of the first learning value.

According to various examples of the present disclosure, it is possible to calculate a learning value that corrects the target lateral position according to the magnitude of the influence on the lateral position error arising from orientation deviation.

### BRIEF DESCRIPTION OF THE DRAWINGS

FIG. 1 is a schematic configuration diagram illustrating an example of a vehicle including a steering control device according to the present disclosure.

FIG. 2 is a plan view for explaining the calculation of the learning value that corrects the target lateral position based on an amount of deviation from the target lateral position.

FIG. 3 is a flowchart illustrating an example of a learning value calculation process.

FIG. 4 is a flowchart illustrating an example of a second learning value calculation process in FIG. 3.

FIG. 5 is a flowchart illustrating an example of a learning speed setting process.

### DETAILED DESCRIPTION

Hereinafter, an example will be described with reference to the drawings. In the following description, the same or equivalent elements are denoted by the same reference numerals, and overlapping explanations may be omitted.

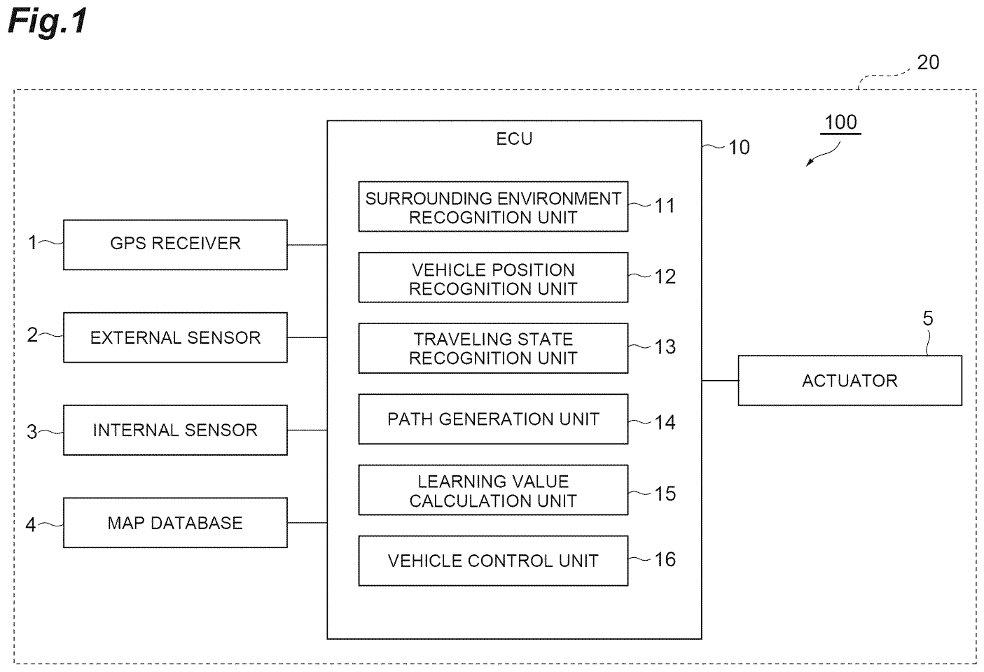

FIG. 1 is a schematic configuration diagram illustrating an example of a vehicle including a steering control device according to the present disclosure. A steering control device 100 shown in FIG. 1 is an autonomous traveling device mounted on a vehicle 20 such as a passenger car. The steering control device 100 is configured to include steering control for the vehicle 20, including steering assistance. Steering assistance is a driving state in which the steering operation of the vehicle 20 by a driver is supported by control. An example of such steering assistance is lane keeping assist (LKA), which encourages the driver to steer the vehicle 20 so as not to deviate from a traveling lane.

The steering control device 100 may also be configured to include steering control for the vehicle 20 with automatic steering. Automatic steering is a driving state in which the steering of the vehicle 20 is automatically controlled. For example, without steering operations by the driver, the vehicle 20 may be automatically steered by the above-mentioned LKA so that the vehicle 20 does not deviate from the traveling lane.

The steering control device 100 may further be configured to include autonomous driving that involves automatic steering. Autonomous driving is vehicle control in which the vehicle 20 travels automatically along a preset target route. The term target route here refers to a route on a map along which the vehicle 20 travels under autonomous driving control. Under autonomous driving, the driver does not perform steering or acceleration/deceleration operations, and the vehicle 20 travels automatically.

In other words, the steering control in the present example may mean at least one of LKA control among steering assistance, automatic steering when not under autonomous driving, and automatic steering during autonomous driving. Among these types of LKA control, steering assistance and automatic steering when not under autonomous driving can be performed, for example, based on a captured image in front of the vehicle 20 obtained by an onboard camera. Any of the LKA controls may also be executed based on map information.

[Configuration of Steering Control Device 100] As shown in FIG. 1, the steering control device 100 includes an ECU (Electronic Control Unit) 10 that governs the steering control. The ECU 10 is an electronic control unit including a Central Processing Unit (CPU), a Read

Only Memory (ROM), a Random Access Memory (RAM), a CAN (Controller Area Network) communication circuit, and so forth. In the ECU 10, for example, various functions are realized by loading a program stored in the ROM into the RAM and executing the program loaded into the RAM by the CPU. The ECU 10 may be formed by multiple electronic control units.

The ECU 10 is connected to a GPS receiver 1, an external sensor 2, an internal sensor 3, a map database 4, and an actuator 5.

The GPS receiver 1 measures the position of the vehicle 20 (for example, the latitude and longitude of the vehicle 20) by receiving signals from three or more GPS satellites. The GPS receiver 1 transmits the measured position information of the vehicle 20 to the ECU 10.

The external sensor 2 is a detector that detects the surroundings of the vehicle 20. The external sensor 2 includes at least a camera. The external sensor 2 may also include a radar sensor.

The camera is an imaging device that captures an external environment of the vehicle 20. The camera is provided on the rear side of the windshield of the vehicle 20. The camera transmits to the ECU 10 captured images of the external environment of the vehicle 20, including the external environment in front of the vehicle 20. The camera may be a monocular camera or a stereo camera.

The radar sensor is a detector that detects obstacles around the vehicle 20 by using radio waves (for example, millimeter waves) or light. The radar sensor includes, for example, a millimeter wave radar or LiDAR (Light Detection And Ranging). The radar sensor transmits radio waves or light around the vehicle 20, receives the radio waves or light reflected by obstacles, and thereby detects obstacles. The radar sensor transmits detected obstacle information to the ECU 10. An obstacle may be, for example, a fixed obstacle that defines a lane on a road, such as a curb, a guardrail, a pole, or a safety cone. The obstacle may also be a moving obstacle such as a pedestrian, a bicycle, or another vehicle.

The internal sensor 3 is a detector that detects a traveling state of the vehicle 20. The internal sensor 3 includes a vehicle speed sensor, an acceleration sensor, and a yaw rate sensor. The vehicle speed sensor is a detector that detects the speed of the vehicle 20. As an example, a wheel speed sensor that detects the rotational speed of the wheels of the vehicle 20 is used as the vehicle speed sensor by being provided on a wheel or a drive shaft that rotates together with the wheel. The vehicle speed sensor transmits the detected vehicle speed information (wheel speed information) to the ECU 10.

The acceleration sensor is a detector that detects an acceleration of the vehicle 20. For example, it includes a longitudinal acceleration sensor that detects the longitudinal acceleration of the vehicle 20 and a lateral acceleration sensor that detects the lateral acceleration of the vehicle 20. The acceleration sensor transmits, for example, acceleration information of the vehicle 20 to the ECU 10. The yaw rate sensor is a detector that detects the yaw rate (rotational angular velocity) of the vehicle 20 about its center of gravity around a vertical axis. As an example, a gyro sensor can be used as the yaw rate sensor. The yaw rate sensor transmits the detected yaw rate information of the vehicle 20 to the ECU 10.

The map database 4 is a database that stores map information. For example, the map database 4 is formed in a storage device such as an HDD (Hard Disk Drive) mounted on the vehicle 20. The map information includes position information of roads, information about road shapes (for example, whether a section is a curve or a straight part, curvature of a curve, whether the curve is a right curve or a left curve, and so on), position information of intersections and branch points, and the like. Note that if the vehicle 20 is not configured to perform autonomous driving, the map database 4 is not indispensable.

The actuator 5 is a device used for controlling the vehicle 20. The actuator 5 at least includes a steering actuator. The steering actuator controls the drive of an assist motor that regulates the steering torque in an electric power steering system, according to a control signal from the ECU 10. In this way, the steering actuator controls the steering torque of the vehicle 20.

The actuator 5 may also include a drive actuator and a brake actuator. The drive actuator controls the air supply (throttle opening) to an engine, for instance, in response to a control signal from the ECU 10, and thereby controls the driving force of the vehicle 20. If the vehicle 20 is a hybrid electric vehicle, in addition to controlling the air supply to the engine, a control signal from the ECU 10 is input to a motor serving as a power source so that the driving force is regulated. If the vehicle 20 is a battery electric vehicle, a control signal from the ECU 10 is input to a motor serving as a power source so that the driving force is regulated. In these cases, the motor serving as a power source forms the actuator 5. The brake actuator controls the brake system in response to the control signal from the ECU 10 and controls the braking force applied to the wheels of the vehicle 20. A hydraulic brake system may be used as the brake system, for example.

Next, the functional configuration of the ECU 10 will be described. The ECU 10 includes a surrounding environment recognition unit 11, a vehicle position recognition unit 12, a traveling state recognition unit 13, a path generation unit 14, a learning value calculation unit 15, and a vehicle control unit (steering control unit) 16. Part of the functions of the ECU 10 may be executed on a server capable of communicating with the vehicle 20.

The surrounding environment recognition unit 11 recognizes a surrounding environment of the vehicle 20 based on a detection result of the external sensor 2. The surrounding environment includes, for example, conditions of lane lines (for instance, white lines) around the vehicle 20. It may also include the conditions of obstacles (including curbs) around the vehicle 20.

The surrounding environment recognition unit 11 obtains a captured image in front of the vehicle 20 by using the camera of the external sensor 2. Based on the captured image in front of the vehicle 20, the surrounding environment recognition unit 11 recognizes the lane lines around the vehicle 20 and identifies the traveling lane of the vehicle 20. By using the radar sensor of the external sensor 2, the surrounding environment recognition unit 11 may also acquire information about obstacles such as a curb in front of the vehicle 20 and thereby identify the traveling lane of the vehicle 20.

The vehicle position recognition unit 12 recognizes the position of the vehicle 20 in the traveling lane or the position of the vehicle 20 on a map. The vehicle position recognition unit 12, for example, recognizes the position of the vehicle 20 in the traveling lane by determining the relative position between the vehicle 20 and the lane lines based on a captured image in front of the vehicle 20 taken by the camera of the external sensor 2. The position of the vehicle 20 in the traveling lane may be calculated, for example, as a coordinate corresponding to a midpoint between a pair of left driving wheels and right driving wheels of the vehicle 20.

Note that, if the vehicle 20 is configured to perform autonomous driving with automatic steering, then based on the position information from the GPS receiver 1 and the map information from the map database 4, the vehicle position recognition unit 12 may recognize the position of the vehicle 20 on the map. The vehicle position recognition unit 12 may also utilize position information of an object included in the map information of the map database 4 and the detection result from the external sensor 2 to precisely recognize the position of the vehicle 20 by a SLAM (Simultaneous Localization and Mapping) technique or the like. Alternatively, the vehicle position recognition unit 12 may recognize the position of the vehicle 20 on the map by other known methods.

The traveling state recognition unit 13 recognizes the traveling state of the vehicle 20 based on the detection result of the internal sensor 3. The traveling state includes the vehicle speed of the vehicle 20, the acceleration of the vehicle 20, and the yaw rate of the vehicle 20. Specifically, the traveling state recognition unit 13 recognizes the vehicle speed of the vehicle 20 based on vehicle speed information from the vehicle speed sensor. The traveling state recognition unit 13 recognizes the acceleration of the vehicle 20 based on acceleration information from the acceleration sensor. The traveling state recognition unit 13 and recognizes the heading of the vehicle 20 based on yaw rate information from the yaw rate sensor.

While steering control is being executed, the driver of the vehicle 20 can perform a manual steering operation. The manual steering operation is an override of the steering operation while the steering control is being executed. The traveling state recognition unit 13 may determine whether or not the driver performed a manual steering operation during the steering control, for example, by detecting whether or not a steering operation was performed by the driver during execution of the steering control, based on a steering angle sensor or a steering torque sensor of the internal sensor 3.

The path generation unit 14 generates a target path including a target lateral position in the traveling lane of the vehicle 20 based on a captured image in front of the vehicle 20. For example, the target path may be target lateral position data (a lateral position profile) of the vehicle 20 in the traveling lane. The target lateral position data may be set as position coordinates in the traveling lane for positions spaced at a certain interval (for example, 1 m) in the traveling direction of the vehicle 20. The target lateral position is the target position in the lane width direction. In this case, the set positions in the traveling direction and the target lateral positions may be associated together as a single set of positional coordinates. The lateral position profile corresponds to trajectory data expressed by associating each set position in the traveling direction with the target lateral position.

If the vehicle 20 is configured to perform autonomous driving with automatic steering, the path generation unit 14 may generate a route used when the vehicle 20 performs autonomous driving by various methods.

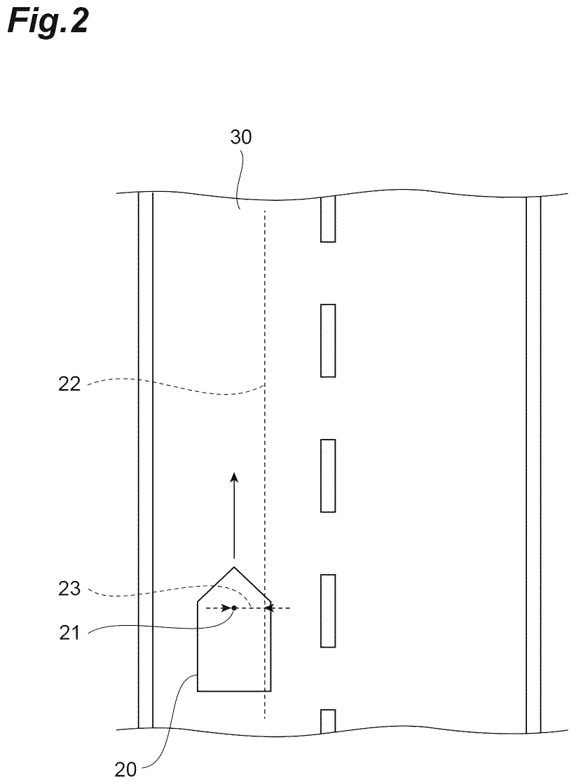

FIG. 2 is a plan view for explaining the calculation of the learning value that corrects the target lateral position based on an amount of deviation from the target lateral position. In the example of FIG. 2, the vehicle 20 under LKA control as steering control is traveling on a road 30 that is a straight road, as shown in a plan view. The position of the vehicle 20 in the traveling lane is shown as a black dot labeled center position 21. The target path 22 for LKA control is shown as a dashed line. The amount of deviation from the target lateral position corresponds to a deviation amount 23, which is the distance in the lane width direction between center position 21 and target path 22.

In the vehicle 20, if no manual steering operation is performed while steering control is being executed, then the actuator 5 is controlled such that the center position 21 is located on the target path 22 of the steering control. In the example of FIG. 2, the driver of the vehicle 20 is actually performing a manual steering operation while the steering control is being executed. For instance, because the target path 22 is shifted right in the traveling lane, the driver is lightly steering to the left so that the vehicle 20 travels near the center of the traveling lane. The phenomenon in which the target path 22 is shifted right in the traveling lane indicates an influence on the lateral position error of the vehicle 20 caused by deviation of the mounted orientation of the camera of the external sensor 2. Note that the shift amount of the target path 22 toward the right in the traveling lane is illustrated in an exaggerated manner in FIG. 2.

The learning value calculation unit 15, when the driver of the vehicle 20 is performing a manual steering operation while steering control is being executed, calculates a learning value that corrects the target lateral position based on the deviation amount 23 by which a manual path of the vehicle 20, following the manual steering operation, differs from the target lateral position in the target path 22.

The manual path of the vehicle 20 that follows the manual steering operation corresponds to a movement track of the center position 21 of the vehicle 20 traveling in response to the manual steering operation performed while steering control is being executed. In accordance with the operation amount of the manual steering, the manual path of the vehicle 20 extends apart from the target path 22. In the example of FIG. 2, the manual path of the vehicle 20 that follows the manual steering can be assumed to be an imaginary line along the solid arrow indicating the traveling direction of the vehicle 20.

The learning value calculation unit 15 calculates a first learning value, which is a learning value when the vehicle 20 is traveling on a straight road, and a second learning value, which is a learning value when the vehicle 20 is traveling on a curved road. The example of FIG. 2 corresponds to a time when the vehicle 20 is traveling on a straight road. Even when the vehicle 20 is traveling on a curved road, center position 21, target path 22, and deviation amount 23 can be defined in a similar manner as in the example of FIG. 2. The first learning value and the second learning value are respectively for straight roads and curved roads, and each is separately stored in the ECU 10.

The learning value calculation unit 15 may determine whether the vehicle 20 is traveling on a straight road or a curved road, for example, based on the shape of a lane line in front of the vehicle 20 in the captured image from the camera of the external sensor 2. The learning value calculation unit 15 may determine whether the vehicle 20 is traveling on a curved road based on the position of the vehicle 20 on the map and the map information.

The learning value calculation unit 15 may calculate a right learning value, which is the second learning value when the vehicle 20 is traveling on a right curved road, and a left learning value, which is the second learning value when the vehicle 20 is traveling on a left curved road. The right learning value is the learning value for a right curved road. The left learning value is the learning value for a left curved road. The ECU 10 may store the right learning value and the left learning value separately.

The learning value calculation unit 15, for example, determines whether the vehicle 20 is traveling on a right curved road based on the bending direction of the lane line in front of the vehicle 20, when the vehicle 20 is traveling on a curved road according to a captured image in front of the vehicle 20. The learning value calculation unit 15 may determine whether the vehicle 20 is traveling on a right curved road based on the position of the vehicle 20 on the map and the map information.

The learning value calculation unit 15 may calculate the learning value so that the learning speed of the second learning value is faster than the learning speed of the first learning value. By changing the calculation cycle of the learning value calculation process, the learning value calculation unit 15 can change the learning speed.

As an example, if the vehicle 20 is traveling on a straight road, the learning value calculation unit 15 sets the calculation cycle of the learning value calculation process to an initial first cycle and thereby sets the calculation speed of the learning value to a first learning speed. If the vehicle 20 is traveling on a curved road, the learning value calculation unit 15 sets the calculation cycle of the learning value calculation process to a second cycle and thereby sets the calculation speed of the learning value to a second learning speed. The second cycle is a shorter cycle for updating the learning value than the first cycle. Accordingly, the second learning speed is a faster calculation speed for the learning value than the first learning speed.

The vehicle control unit 16 executes steering control based on the target path and the learning value. If the driver is performing a manual steering operation while the steering control is being executed, the vehicle control unit 16 may suspend execution of the steering control and wait for the above-described learning value calculation unit 15 to calculate the learning value. If the driver is not performing a manual steering operation while steering control is being executed, the vehicle control unit 16 may resume execution of the steering control in accordance with the learning value calculated by the above-described learning value calculation unit 15. For example, the vehicle control unit 16 may correct the position in the lane width direction of the target path using the stored learning value, and execute steering control by targeting the corrected position in the lane width direction.

In the example of FIG. 2, assume that, while the steering control is being executed and a manual steering operation is taking place, a learning value corresponding to the deviation amount 23 is stored. In that case, once the manual steering operation stops during the steering control, the target path 22 is corrected by that deviation amount 23 in the lane width direction. As a result, steering control is executed so that the center position 21 moves along the solid arrow.

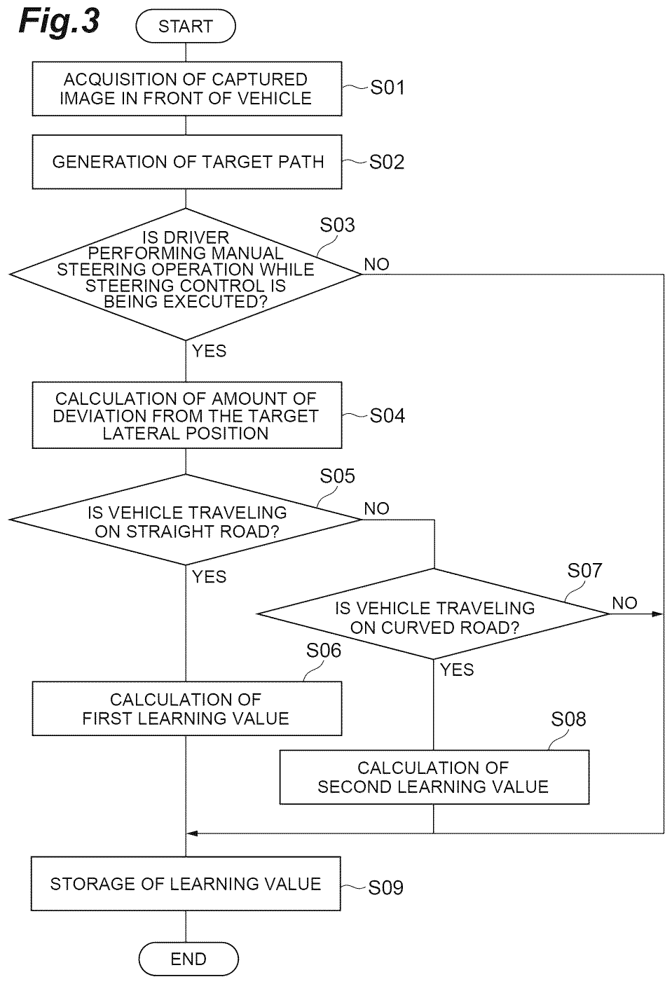

Note that, if the vehicle 20 is configured to perform autonomous driving, the vehicle control unit 16 may function to execute autonomous driving of the vehicle 20 based on the route generated by the path generation unit 14. As part of autonomous driving of the vehicle 20, the steering control as described above may be executed.

[Example of Processing by the ECU 10] Next, an example of processing performed by the ECU 10 will be explained. FIG. 3 is a flowchart illustrating an example of a learning value calculation process. The process shown in FIG. 3 is repeated at a predetermined cycle while steering control (including steering assistance or automatic steering) of the vehicle 20 is being executed.

As shown in FIG. 3, in S01 the ECU 10 acquires the captured image in front of the vehicle 20 by the surrounding environment recognition unit 11. The surrounding environment recognition unit 11 obtains a captured image in front of the vehicle 20 by using the camera of the external sensor 2.

In S02, the ECU 10 generates a target path by the path generation unit 14. Based on the captured image in front of the vehicle 20, the path generation unit 14 generates a target path that includes a target lateral position in the traveling lane of the vehicle 20.

In S03, the ECU 10 determines, by the learning value calculation unit 15, whether the driver is performing a manual steering operation while the steering control is being executed. For example, the learning value calculation unit 15 determines whether there has been a manual steering operation by the driver during execution of steering control, based on whether a steering operation by the driver has been detected by a steering sensor or the like of the internal sensor 3 while steering control is being executed. If it is determined by the learning value calculation unit 15 that the driver has performed a manual steering operation while steering control is being executed (S03: YES), the ECU 10 suspends steering control and proceeds to S04.

In S04, the ECU 10 calculates the amount of deviation from the target lateral position by the learning value calculation unit 15. For example, the learning value calculation unit 15 calculates the deviation amount 23 by finding the distance in the lane width direction between the center position 21 and the target path 22.

In S05, the ECU 10 determines, by the learning value calculation unit 15, whether the vehicle 20 is traveling on a straight road. For example, the learning value calculation unit 15 determines whether the vehicle 20 is traveling on a straight road based on the captured image in front of the vehicle 20. The learning value calculation unit 15 may determine whether the vehicle 20 is traveling on a straight road based on the position of the vehicle 20 on the map and the map information.

If the learning value calculation unit 15 determines that the vehicle 20 is traveling on a straight road (S05: YES), the ECU 10 proceeds to S06. In S06, the ECU 10 calculates the first learning value by the learning value calculation unit 15. For example, the learning value calculation unit 15 multiplies the calculated deviation amount 23 by a certain proportional coefficient and adds the result to the previous value of the first learning value to obtain the first learning value when the vehicle 20 is traveling on a straight road. In S09, the ECU 10 stores the learning value by the learning value calculation unit 15. The learning value calculation unit 15 stores the calculated first learning value as the learning value. The ECU 10 then ends the process of FIG. 3.

On the other hand, if the learning value calculation unit 15 determines that the vehicle 20 is not traveling on a straight road (S05: NO), the ECU 10 proceeds to S07. In S07, the ECU 10 determines, by the learning value calculation unit 15, whether the vehicle 20 is traveling on a curved road. For example, the learning value calculation unit 15 determines whether the vehicle 20 is traveling on a curved road based on the captured image in front of the vehicle 20. The learning value calculation unit 15 may determine whether the vehicle 20 is traveling on a curved road based on the position of the vehicle 20 on the map and the map information.

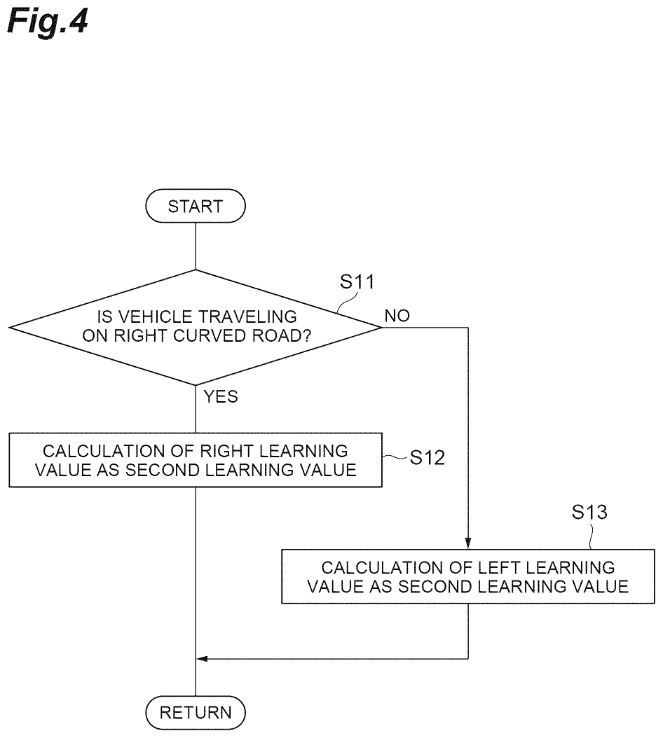

If the learning value calculation unit 15 determines that the vehicle 20 is traveling on a curved road (S07: YES), the ECU 10 proceeds to S08. In S08, the ECU 10 calculates the second learning value by the learning value calculation unit 15. The learning value calculation unit 15 calculates the second learning value, which is the learning value when the vehicle 20 is traveling on a curved road, using the process of FIG. 4 described below, for example. In S09, the ECU 10 stores the learning value by the learning value calculation unit 15. The learning value calculation unit 15 stores the calculated second learning value as the learning value. The ECU 10 then ends the process of FIG. 3.

If it is determined by the learning value calculation unit 15 that there is no manual steering operation by the driver while steering control is being executed (S03: NO), the ECU 10 executes the steering control and ends the process of FIG. 3. After the learning of FIG. 3 is performed, the ECU 10 may resume steering control by the vehicle control unit 16. For example, if the driver who had been performing a manual steering operation during execution of the steering control ceases the manual steering operation, the vehicle control unit 16 executes the steering control based on the stored learning value and the target path.

FIG. 4 is a flowchart illustrating an example of a second learning value calculation process in FIG. 3. In S11, the ECU 10 determines, by the learning value calculation unit 15, whether the vehicle 20 is traveling on a right curved road. For example, the learning value calculation unit 15 determines whether the vehicle 20 is traveling on a right curved road based on the captured image in front of the vehicle 20. The learning value calculation unit 15 may determine whether the vehicle 20 is traveling on a right curved road based on the position of the vehicle 20 on the map and the map information.

If the learning value calculation unit 15 determines that the vehicle 20 is traveling on a right curved road (S11: YES), the ECU 10 proceeds to S12. In S12, the ECU 10 calculates a right learning value as the second learning value by the learning value calculation unit 15. For example, the learning value calculation unit 15 multiplies the calculated deviation amount 23 by a certain proportional coefficient and adds the result to the previous value of the second learning value, thereby calculating the right learning value as the second learning value when the vehicle 20 is traveling on a right curved road. The ECU 10 then ends the process of FIG. 4 and returns to the process of FIG. 3.

If the learning value calculation unit 15 determines that the vehicle 20 is not traveling on a right curved road (namely, the vehicle 20 is traveling on a left curved road) (S11: NO), the ECU 10 proceeds to S13. In S13, the ECU 10 calculates a left learning value as the second learning value by the learning value calculation unit 15. For example, the learning value calculation unit 15 multiplies the calculated deviation amount 23 by a certain proportional coefficient and adds the result to the previous value of the second learning value, thereby calculating the left learning value as the second learning value when the vehicle 20 is traveling on a left curved road. The ECU 10 then ends the process of FIG. 4 and returns to the process of FIG. 3.

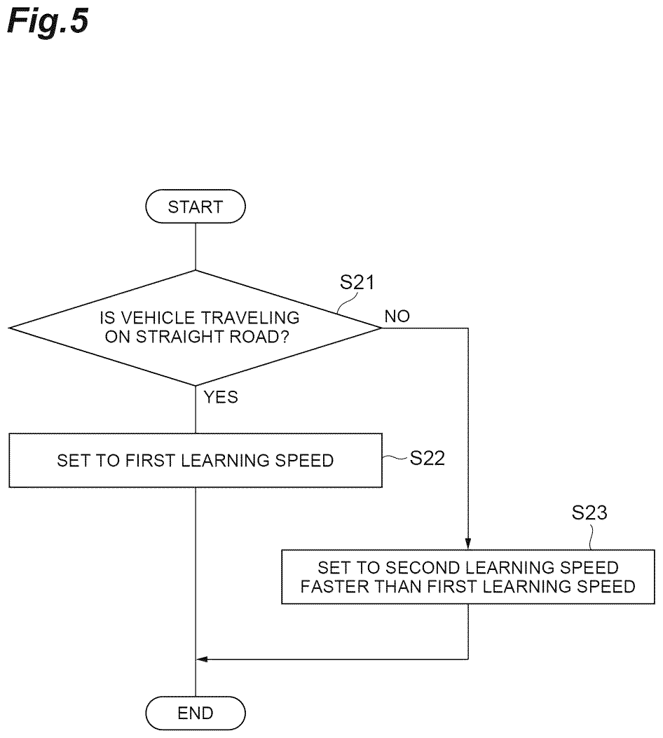

FIG. 5 is a flowchart illustrating an example of a learning speed setting process. The process shown in FIG. 5 may be repeated at a predetermined cycle, in parallel with the process of FIG. 3, while steering control (including steering assistance or automatic steering) of the vehicle 20 is being executed.

In S21, the ECU 10 determines, by the learning value calculation unit 15, whether the vehicle 20 is traveling on a straight road. For example, the learning value calculation unit 15 determines whether the vehicle 20 is traveling on a straight road based on the captured image in front of the vehicle 20. The learning value calculation unit 15 may determine whether the vehicle 20 is traveling on a straight road based on the position of the vehicle 20 on the map and the map information.

If the learning value calculation unit 15 determines that the vehicle 20 is traveling on a straight road (S21: YES), the ECU 10 proceeds to S22. In S22, the ECU 10 sets the calculation speed of the learning value to the first learning speed by the learning value calculation unit 15. For example, the learning value calculation unit 15 sets the predetermined cycle for repeatedly executing the process of FIG. 3 to a first cycle, thereby setting the calculation speed of the learning value to the first learning speed. The ECU 10 then ends the process of FIG. 5.

If the learning value calculation unit 15 determines that the vehicle 20 is not traveling on a straight road (namely, the vehicle 20 is traveling on a curved road) (S21: NO), the ECU 10 proceeds to S23. In S23, the ECU 10 sets the calculation speed of the learning value to a second learning speed, which is faster than the first learning speed, by the learning value calculation unit 15. For example, the learning value calculation unit 15 sets the predetermined cycle for repeatedly executing the process of FIG. 3 to a second cycle, thereby setting the calculation speed of the learning value to the second learning speed. The ECU 10 then ends the process of FIG. 5.

According to the steering control device 100 described above, the first learning value for a straight road and the second learning value for a curved road are calculated as learning values that correct the target lateral position. The lateral position error (the deviation amount 23) on road 30 on which the vehicle 20 travels can arise from a deviation in the mounted orientation of the camera that captures images. The deviation amount 23 arising from the deviation of the mounted orientation may vary between a straight road and a curved road, for example, tending to be larger on a curved road than on a straight road. With the above configuration, the first learning value for a straight road and the second learning value for a curved road can be calculated as different values from one another. Hence, it is possible to calculate a learning value that corrects the target lateral position according to how strongly the lateral position error is influenced by the deviation of the mounted orientation.

In the steering control device 100, the learning value calculation unit 15 calculates a right learning value (the second learning value when the vehicle 20 is traveling on a right curved road) and a left learning value (the second learning value when the vehicle 20 is traveling on a left curved road). Accordingly, a deviation in the mounted orientation that causes an error in the lateral position of the vehicle 20 might not affect right-curved travel and left-curved travel in the same manner. With the above configuration, the right learning value for a right curved road and the left learning value for a left curved road can be calculated as distinct values. Thus, each second learning value can be calculated according to the difference in the impact on lateral position error that arises from the mounted orientation deviation during right-curved travel and during left-curved travel.

In the steering control device 100, the learning value calculation unit 15 calculates the learning value such that the second learning value has a faster learning speed than the first learning value. By making the learning speed during travel on a curved road faster than the learning speed during travel on a straight road, it becomes feasible to correct the lateral position of the vehicle at an early stage on a curved road, where the influence on the lateral position error tends to be larger.

[Modifications] The present disclosure is not limited to the above-described example. The present disclosure may be carried out in various forms with various changes and refinements made on the basis of the knowledge of those skilled in the field.

In the above example, the learning value calculation unit 15 calculates a right learning value (the second learning value when the vehicle 20 is traveling on a right curved road) and a left learning value (the second learning value when the vehicle 20 is traveling on a left curved road), but this arrangement is not indispensable. The second learning value may be a common learning value for both a right curved road and a left curved road. The learning value calculation unit 15 need only calculate at least a first learning value (which is the learning value when the vehicle 20 is traveling on a straight road) and a second learning value (which is the learning value when the vehicle 20 is traveling on a curved road) separately.

In the above example, the learning value calculation unit 15 calculates the learning value so that the second learning value has a faster learning speed than the first learning value, but this arrangement is not indispensable. The learning value calculation unit 15 may calculate the first learning value and the second learning value at the same learning speed.

In the above example, the vehicle 20 was configured to perform autonomous driving, but this arrangement is not indispensable. In a vehicle 20 that does not perform autonomous driving, the steering control device 100 may be configured to perform steering control including steering assistance or automatic steering. In that case, any configuration used for autonomous driving but not for the steering control including steering assistance or automatic steering (such as the GPS receiver 1 or map database 4) may be omitted.

What is claimed is:

1. A steering control device configured to execute steering control including steering assistance or automatic steering of a vehicle, comprising:
a path generation unit configured to generate a target path including a target lateral position in a traveling lane of the vehicle based on a captured image in front of the vehicle;
a learning value calculation unit configured to, when a driver of the vehicle is performing a manual steering operation while the steering control is being executed, calculate a learning value for correcting the target lateral position based on an amount of deviation of a manual path of the vehicle that follows the manual steering operation from the target lateral position in the target path; and
a steering control unit configured to execute the steering control based on the target path and the learning value;
wherein the learning value calculation unit calculates a first learning value that is the learning value when the vehicle is traveling on a straight road, and a second learning value that is the learning value when the vehicle is traveling on a curved road.

2. The steering control device according to claim 1, wherein
the learning value calculation unit calculates a right learning value that is the second learning value when the vehicle is traveling on a right curved road, and a left learning value that is the second learning value when the vehicle is traveling on a left curved road.

3. The steering control device according to claim 1, wherein
the learning value calculation unit calculates the learning value so that a learning speed of the second learning value is faster than a learning speed of the first learning value.

4. The steering control device according to claim 2, wherein
the learning value calculation unit calculates the learning value so that a learning speed of the second learning value is faster than a learning speed of the first learning value.
